(19) United States
(12) Patent Application Publication
(10) Pub. No.: US 2023/0192220 A1
(43) Pub. Date: Jun. 22, 2023

(54) TWO-WHEELED VEHICLE ACCIDENT OCCURRENCE REPORT DEVICE HAVING RETROREFLECTION COVER, DEEP LEARNING RECOGNITION-BASED TWO-WHEELED VEHICLE ACCIDENT SEVERITY PREDICTION SERVER, AND TWO-WHEELED VEHICLE ACCIDENT SEVERITY PREDICTION SYSTEM COMPRISING SAME

(71) Applicants: Jong Yeol NA, Gyeonggi-do (KR); POG Inc., Gyeonggi-do (KR)

(72) Inventor: Jong Yeol Na, Gyeonggi-do (KR)

(21) Appl. No.: 17/920,708

(22) PCT Filed: Dec. 14, 2021
(86) PCT No.: PCT/KR2021/018942

§ 371 Date: Oct. 21, 2022

(30) Foreign Application Priority Data
Feb. 23, 2021 (KR) 10-2021-0023825

(51) Int. Cl. B62J 45/41; G05B 13/02

(52) U.S. Cl. CPC B62J 45/41; G05B 13/027

(57) ABSTRACT

The present invention relates to a two-wheeled vehicle accident reporting device having a retro-reflective cover, a deep learning recognition-based two-wheeled vehicle accident severity prediction server, and a two-wheeled vehicle accident severity prediction system including the same. The above reporting device includes: a body mounted on a two-wheeled vehicle; a retro-reflective cover having one end fixed to a lower end of the body, which is configured to be folded and unfolded in a scallop shape and reflects light; and a control board which is mounted on one side of the body, measures the speed and position of the two-wheeled vehicle using a plurality of sensors, and transmits accident occurrence information including speed information, impact amount information, location information and time information along with driver identification information through a wireless communication network to a two-wheeled vehicle accident severity prediction server when an accident occurs.

### TECHNICAL FIELD

The present invention relates to an accident prediction system, and more particularly, to a two-wheeled vehicle accident reporting device provided with a retro-reflective cover, a deep learning recognition-based two-wheeled vehicle accident severity prediction server, and a two-wheeled vehicle accident severity prediction system including the same.

### BACKGROUND ART

Two-wheel vehicles generally run on the road and often drive too fast. Therefore, the two-wheel vehicle has a mortality rate when an accident occurs due to contact with a vehicle on the road or due to negligence of a passenger.

In the case of a single accident of a two-wheeled vehicle, for example, a bicycle, a kickboard, an electric kickboard or an electric wheel, most passengers do not have fellow passengers, and thus the damage is often expanded due to the delay in handling after the accident.

For rapid post-treatment, there is an existing technology that reports to the police station through a mobile application when an amount of shock greater than a certain threshold is detected, however, it is inefficient to link the report to the police at all occasions without judging the severity of the accident, while consuming unnecessary social cost.

For example, there are many cases where, although police officers and firefighters have been dispatched, it may be a minor accident that ends up with an agreement between the insurance companies. Alternatively, there may also be cases where, although the police officers have been dispatched, it is a serious injury accident and corresponding actions are delayed. In other words, there was no way to determine the severity of the accident at the time of reporting for a two-wheeled vehicle.

### SUMMARY OF INVENTION

### Problems to be Solved by Invention

The present specification has been devised to solve the above problems, and an abject of the present invention is to provide a deep learning recognition-based two-wheeled vehicle accident severity prediction server capable of promptly and appropriately providing relief efforts in the event of an accident of a two-wheeled vehicle, and a two-wheeled vehicle accident severity prediction system including the same.

Another object of the present invention is to provide a two-wheeled vehicle accident reporting device having a retro-reflective cover that shows high visibility by supplementing the limitations of the front and rear-oriented reflective functions of the existing reflector and the shortcomings of the small size.

A still further object of the present invention is to provide a deep learning recognition-based two-wheeled vehicle accident severity prediction server capable of alleviating extreme stress in the accident handling process of a victim, and a two-wheeled vehicle accident severity prediction system including the same.

### Means for Solving Problems

According to an embodiment of the present specification, there is provided an apparatus for reporting occurrence of an accident of a two-wheeled vehicle according to the present specification, including: a body mounted on a two-wheeled vehicle; a retro-reflective cover which has one end fixed to a lower end of the body and thus is configured to be folded and unfolded in a scallop shape, and reflects light; and a control board which is mounted on one side of the body, measures the speed and position of the two-wheeled vehicle using a plurality of sensors and, when an accident occurs, transmits accident occurrence information including speed information, impact amount information, location information and time information along with driver identification information through a wireless communication network to a two-wheeled vehicle accident severity prediction server.

Preferably, the body is characterized in that it is mounted on the lower portion of a top tube in the two-wheeled vehicle.

Preferably, the retro-reflective cover is characterized in that the other end is fixed to a down tube in the two-wheeled vehicle when unfolded.

Preferably, the control board is characterized in that it includes an acceleration sensor for measuring the speed and impact amount of the two-wheeled vehicle, and a GPS sensor for measuring the position of the two-wheeled vehicle.

Preferably, the body is mounted on any one of the top tube, the town tube, a seat tube, a head tube or a handle shaft of the two-wheeled vehicle, and the retro-reflective cover is fixed to one part of the body and may be folded and unfolded in a scallop shape. In the unfolded state, the other end of the retro-reflective cover may be fixed to any one or more of the aforementioned top tube, town tube, seat tube, head tube or handle shaft of the two-wheeled vehicle.

Further, the other end of the retro-reflective cover is not necessarily fixed to the top tube, down tube, seat tube, head tube or handle shaft of the two-wheeled vehicle.

Alternatively, the other end of the retro-reflective cover may be maintained to be positioned at a desired site while the retro-reflective cover is unfolded by the fixing force of a bump part able to be folded and unfolded (“foldable bump”)

According to another embodiment of the present specification, the deep learning recognition-based two-wheeled vehicle accident severity prediction server according to the present specification may include: a plurality of memories for storing a plurality of body information; and one or more processors to constitute a neural network that receives the accident occurrence information including, for example, speed information, impact amount information, location information and time information along with drive identification information from a two-wheeled vehicle accident reporting device mounted on a two-wheeled vehicle through a wireless communication network, analyzes road information and weather information at the corresponding location based on the location information, and then, conducts deep-learning of the body information corresponding to the driver identification information among the plurality of body information as well as the speed information, impact amount information, road information, weather information and time information, thereby determining accident severity.

Preferably, the one or more processors may be characterized in that the accident is notified to different relief organizations for each accident severity according to the deep learning result.

Preferably, a learning rate, a goal and the number of epochs, which are hyper parameters determined during learning, may be set to 0.00002, 0.000001 and 100, respectively.

Preferably, the body information may be characterized by including a height, weight, blood type, and body parts with prior medical history.

Preferably, the one or more processors may impart the priority to the subject contacts based on at least one of the number of calls of a mobile terminal possessed by the driver, call time, call time history, number of texts, number of mobile messenger access times, number of mobile messenger tag times, and number of times associated with stored pictures, and then notify the accident to the corresponding contact for each accident severity according to the deep learning result.

According to another embodiment of the present specification, the two-wheeled vehicle accident severity prediction system according to the present specification may include: a two-wheel vehicle accident reporting device, which is mounted on a two-wheeled vehicle, measures the speed and position of the two-wheeled vehicle using a plurality of sensors and, when an accident occurs, transmits accident occurrence information including speed information, impact amount information, location information and time information along with driver identification information through a wireless communication network; and a deep learning recognition-based two-wheeled vehicle accident severity prediction server provided with one or more processors to constitute a neural network, which stores a plurality of body information, analyzes road information and weather information at a corresponding location based on the location information received from the two-wheeled vehicle accident reporting device, and then, conducts deep learning of the body information corresponding to the driver identification information among the plurality of body information, as well as the speed information, impact amount information, road information, weather information and time information so as to determine accident severity, and then, notifies the accident to different relief organizations for each accident severity according to the deep learning result.

### Advantageous Effects

According to the present specification as described above, a two-wheeled vehicle accident reporting device having a retro-reflective cover, which is configured to be folded and unfolded in a scallop shape and reflects light, may be provided so as to supplement the limitations of front and rear-oriented reflective functions of the existing reflectors (rear reflector, pedal reflector and side reflector) as well as shortcomings of a small size, thereby exhibiting high visibility and reducing traffic accidents. Further, the retro-reflective cover according to the present invention can replace the function of a luminous band and/or luminous clothing even if the drive does not wear the same.

Further, a deep learning recognition-based two-wheeled vehicle accident severity prediction server and a two-wheeled vehicle accident severity prediction system may be provided to determine accident severity in a deep learning manner when an accident occurs, thereby implementing promptly and appropriate relief measures.

In addition, a deep learning recognition-based two-wheeled vehicle accident severity prediction server and a two-wheeled vehicle accident severity prediction system may be provided to implement an one-stop service personalized to the accident victim, thereby alleviating extreme stress in the accident handling process of victims

### BRIEF DESCRIPTION OF DRAWINGS

FIG. 1 illustrates a schematic configuration of a two-wheeled vehicle accident severity prediction system according to an embodiment of the present invention;

FIG. 2 illustrates the external appearance of a two-wheeled vehicle accident reporting device according to an embodiment of the present invention;

FIG. 3 is a block diagram showing a schematic configuration inside a control board according to an embodiment of the present invention;

FIG. 4 is a block diagram showing a schematic configuration of the inside of a deep learning recognition-based two-wheeled vehicle accident severity prediction server according to an embodiment of the present invention;

FIG. 5 is a block diagram showing an example of hardware capable of realizing the function of the two-wheeled vehicle accident severity prediction server according to an embodiment of the present invention;

FIG. 6 is a flowchart illustrating a method for predicting the accident severity of a two-wheeled vehicle based on deep learning recognition according to an embodiment of the present invention;

FIGS. 7, 9 and 11 illustrate a state in which a two-wheeled vehicle accident reporting device is mounted on a two-wheeled vehicle and thus a retro-reflective cover is unfolded;

FIGS. 8 and 10 illustrate a state in which the retro-reflective cover is folded; and

FIG. 12 illustrates a state in which a two-wheeled vehicle is mounted according to another embodiment of the present invention.

### MODE FOR CARRYING OUT INVENTION

It should be noted that the technical terms used herein are used only to describe specific embodiments, and are not intended to limit the present invention. Further, the technical terms used in this specification should be interpreted in the meaning generally understood by those of ordinary skill in the art to which the present invention belongs (“those skilled in the art”) without excessively inclusive or reduced meanings, unless otherwise defined in this specification. Further, when the technical terms used in the present specification are incorrect technical terms that do not accurately express the spirit of the present invention, they should be understood by being replaced with technical terms that those skilled in the art can correctly understand. In addition, general terms used in the present invention should be interpreted as defined in advance or according to the context before and after, and should not be interpreted in an excessively reduced meaning.

Further, as used herein, the singular expression includes the plural expression unless the context clearly dictates otherwise. In the present application, terms such as “consisting of” or “comprising” should not be construed as necessarily including all of various components or various steps described in the specification, instead, some components or some steps of which may not be included or additional components or steps may further be included.

Further, the suffixes “module” and “part (or unit)” for the components used in this specification are given or compatibly used in consideration of the ease of writing the specification, and do not have distinct meanings or roles by themselves.

Further, terms including an ordinal number such as first, second, etc. used herein may be used to describe various elements, but the elements should not be limited by the terms. The above terms are used only for the purpose of distinguishing one component from another. For example, without departing from the scope of the present invention, a first component may be referred to as a second component, and similarly, the second component may also be referred to as a first component.

Hereinafter, a preferred embodiment according to the present invention will be described in detail with reference to the accompanying drawings, but the same or similar components are assigned the same reference numerals regardless of reference numerals, and redundant description thereof will be omitted.

Further, in the description of the present invention, if it is determined that a detailed description of a related known technology may obscure the gist of the present invention, the detailed description thereof will be omitted. In addition, it should be noted that the accompanying drawings are only for easy understanding the spirit of the present invention, and should not be construed as limiting the spirit of the present invention by the accompanying drawings.

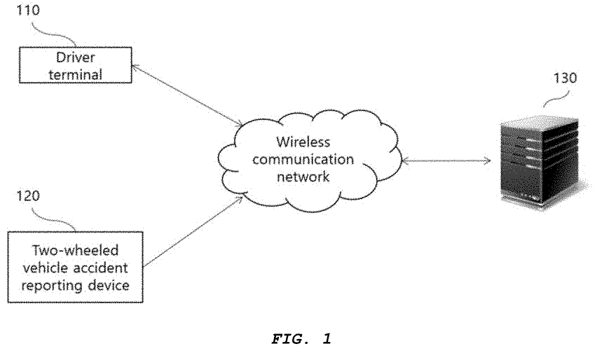

FIG. 1 illustrates a schematic configuration of a two-wheeled vehicle accident severity prediction system according to an embodiment of the present invention.

Referring to FIG. 1, the system for predicting the accident severity of a two-wheeled vehicle according to the present invention may include a driver terminal 110, a two-wheeled vehicle accident reporting device 120, and a two-wheeled vehicle accident severity prediction server 130.

The driver terminal 110 is a mobile terminal possessed by a driver of a two-wheeled vehicle such as a bicycle, a motorcycle, a kickboard, an electric kickboard, an electric wheel, and the like, by which the driver may access the two-wheel accident severity prediction server 130 and sign up for an accident report service by entering body information including the weight, height, blood type, and body part with prior medical history (a part with injury before the accident) of the driver along with driver information including the name, age, identification number and phone number of the driver. Meanwhile, although a two-wheeled vehicle is indicated in this specification, the two-wheeled vehicle may also include an electric wheel having one or two wheels,

Further, the driver terminal 110 may be paired with the two-wheeled vehicle accident reporting device 120 mounted on the two-wheeled vehicle to transmit data between the two-wheeled vehicle accident reporting device 120 and the two-wheeled vehicle accident severity prediction server 130. In other words, the driver terminal 110 may transmit accident occurrence information including speed information, impact amount information, location information and time information along with driver identification information received from the two-wheeled vehicle accident reporting device 120 to the two-wheeled vehicle accident severity prediction server 130. Further, according to a request from the two-wheeled vehicle accident severity prediction server 130, the driver terminal 110 may provide the number of calls, call time, call time history, number of texts, the number of access times to the mobile messenger, the number of mobile messenger tags, and the number of times associated with the stored pictures to the two-wheeled vehicle accident severity prediction server 130.

The driver terminal 110 described herein may include, for example, a mobile phone, a smart phone, a laptop computer, a digital broadcasting terminal, personal digital assistants (PDA), a portable multimedia player (PMP), a navigation system, a slate PC, a tablet PC, an ultra note-book, a wearable device such as watch-type terminal (smart watch), a glass-type terminal (smart glass), HMD (head mounted display), and the like.

However, those skilled in the art will readily appreciate that the configuration according to the embodiment described in the present specification may also be applied to fixed terminals such as digital TV, desktop computer, digital signage, etc., except when applicable only to mobile terminals.

Meanwhile, the driver terminal 110 according to the present invention may be omitted when the two-wheeled vehicle accident reporting device 120 and the two-wheeled vehicle accident severity prediction server 130 are directly connected to each other through a wireless communication network to transmit and receive data.

The two-wheeled vehicle accident reporting device 120 is mounted on the two-wheeled vehicle, measures the speed, the amount of impact and the position of the two-wheeled vehicle, is paired with the driver terminal 110 and, when an accident occurs, transmits accident occurrence information including speed information, impact amount information, location information, and time information along with the driver identification information to the two-wheeled vehicle accident severity prediction server 130 through the driver terminal 110. In this case, the two-wheeled vehicle accident reporting device 120 may determine that an accidents has occurred if the impact amount is greater than or equal to a preset threshold, and then, may transmit accident occurrence information including speed information, impact amount information, locating information and time information along with the driver identification information to the two-wheeled vehicle accident severity prediction server 130.

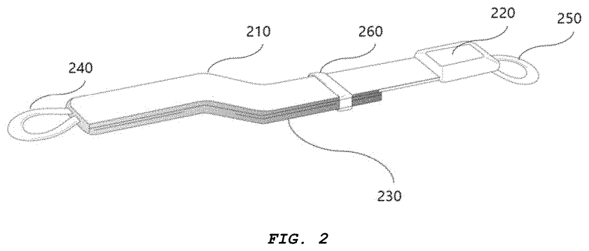

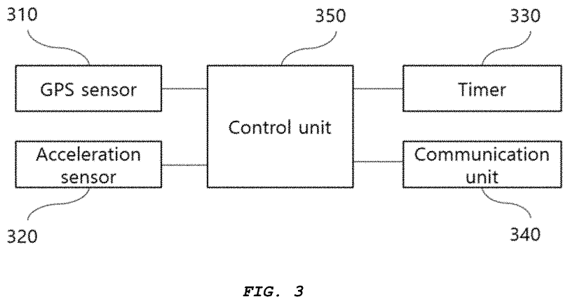

Further, the two-wheeled vehicle accident reporting device 120 is configured to be folded and unfolded in a scallop shape, and may include a retro-reflective cover to reflect light. For the detailed configuration of the two-wheeled vehicle accident reporting device 120, it will be described with reference to FIGS. 2 and 3.

The two-wheeled vehicle accident severity prediction server 130 stores a plurality of body information, receives accident occurrence information including speed information, impact amount information, location information and time information along with driver identification information from the two-wheeled vehicle accident reporting device 120 through a driver terminal 110 when an accident occurs in the two-wheeled vehicle, analyzes road information and weather information at a corresponding site based on the location information, and then, determines accident severity by deep learning the body information, speed information, impact amount information, road information, weather information and time information, which correspond to the driver identification information, among the plurality of stored body information. That is, the two-wheeled vehicle accident severity prediction server 130 may classify accidents into four (4) types of unknown, minor, severe and fetal injuries based on the input value through a deep learning algorithm for accident severity, in which two hidden layers are provided. Herein, the input value may comprise four (4) types of information among the body information of the victim of a bicycle accident, such as height, weight, blood type and both part with prior medical history, as well as five (5) types of information including impact amount, driving speed just before the accident, road type, weather and accident time, which are information at the time of the accident. That is, the above total 9 input values may be classified into final four (4) types of accidents through optimized weighted value and activation functions determined by training the deep learning algorithm. At this time, hyper parameters determined during learning, specifically, a learning rate, a goal and the number of epochs may be preset as 0.00002, 0.00001 and 100, respectively.

The two-wheeled vehicle accident severity prediction server 130 may notify the accident to different relief organizations for each accident severity according to the deep learning result. For example: if the accident severity is unknown, the two-wheeled vehicle accident severity prediction server 130 may contact an acquaintance immediately after the accident occurs; if the accident severity is minor, the above server may contact the acquaintance and insurance company (or the jurisdiction city hall (in the case of group insurance)); if the accident is serious, the server may contact acquaintances, insurance company and police station; and, if the accident severity is fatal injuries, the sever may contact acquaintances, insurance company, police station and ambulance. Further, in the case of post-treatment of an accident when a predetermined time has elapsed immediately after the accident, the two-wheeled vehicle accident severity prediction server 130 may match a company suitable for accident severity such as a hospital, a claim adjuster, a repair company and a funeral service company, and then, may provide the above process to the driver terminal 110.

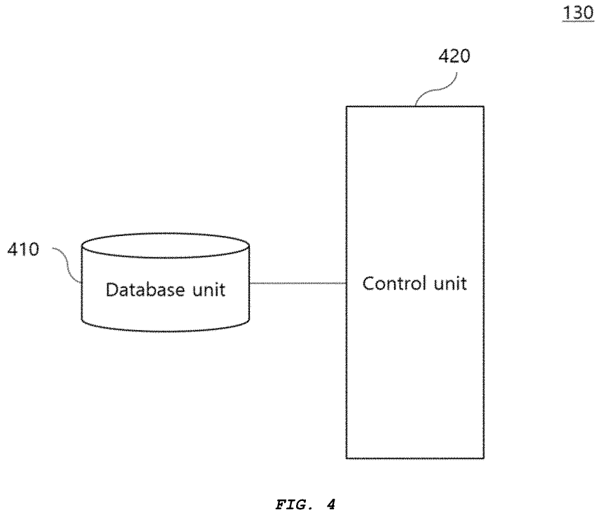

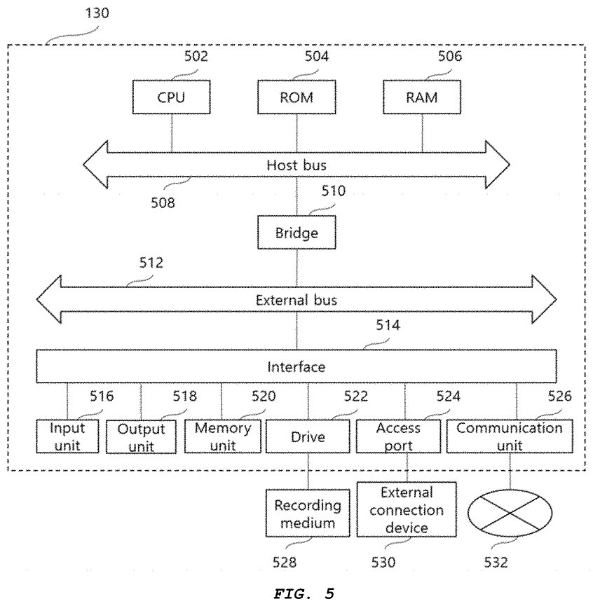

Further, the two-wheeled vehicle accident severity prediction server 130 may impart the priority to the subject contacts based on at least one of the number of calls of the driver terminal 110, call time, call time history, number of texts, number of mobile messenger access times, number of mobile messenger tag times, and number of times associated with stored pictures, and then notify the accident to the corresponding contact for each accident severity according to the deep learning result. Meanwhile, a detailed configuration of the two-wheeled vehicle accident severity prediction server 130 according to the present invention will be described with reference to FIGS. 4 and 5.

FIG. 2 shows the external appearance of a two-wheeled vehicle accident reporting device according to an embodiment of the present invention.

Referring to FIG. 2, the two-wheeled vehicle accident reporting device 120 according to the present invention may include a body 210, a control board 220, a retro-reflective cover 230, a first fixture 240 and a second fixture 250.

The body 210 is composed of an elongated plate-shaped frame, and is provided on a lower portion of the top tube in the two-wheeled vehicle by the first fixture 240 and the second fixture 250.

The control board 220 is mounted on one side of the body 210, measures the speed, the amount of impact and the position of the two-wheeled vehicle using a plurality of sensors and, when an accident occurs, transmits accident occurrence information including speed information, impact amount information, location information and time information along with driver identification information to the two-wheeled vehicle accident severity prediction server 130 through the driver terminal 110s. Meanwhile, a detailed configuration of the control board 220 will be described with reference to FIG. 3.

The retro-reflective cover 230 is configured to be folded and unfolded in a scallop shape, in which one end is fixed to the lower end of the body 210 while the other end is fixed to the down tube of the two-wheeled vehicle when unfolded. The driver can operate the vehicle while folding the retro-reflective cover 230 during the day, and may operate while unfolding the retro-reflective cover 230 at night.

The retro-reflective cover 230 may have a wide retro-reflective surface (e.g., 50 cm in width×40 cm in length, 1,200 cm² in area) with high luminance. Herein, the retro-reflective cover 230 is preferably made of a reflective fiber material capable of reflecting light, thereby remarkably improving visibility of the vehicle driver.

The first fixture 240 may be provided in the form of a ring at one end of the body 210 and fitted to the head tube of the two-wheeled vehicle. The second fixture 250 may be provided in the form of a ring at the other end of the body 210 and fitted into the seat tube of the two-wheeled vehicle. A configuration in which the first fixture 240 and the second fixture 250 are respectively fixed to the head tube and seat tube of the two-wheeled vehicle will be described with reference to FIG. 7.

In addition, the two-wheeled vehicle accident reporting device 120 may further include a fixing band 260 for securing the retro-reflective cover 230 to the body 210 when the retro-reflective cover 230 is folded.

FIG. 3 is a block diagram illustrating a schematic configuration of the inside of a control board according to an embodiment of the present invention.

Referring to FIG. 3, the control board 220 according to the present invention may include a GPS sensor 310, an acceleration sensor 320, a timer 330, a communication unit 340 and a control unit 350.

The GPS sensor 310 detects the current movement pattern of the two-wheeled vehicle, converts it into an electrical signal and outputs the signal to the control unit 350. That is, the GPS sensor 310 may detect the current position of the two-wheeled vehicle and output the information to the control unit 350. In other words, the GPS sensor 310 outputs the location information of the two-wheeled vehicle, on which the two-wheeled vehicle accident reporting device 120 is mounted, to the control unit 350.

The acceleration sensor 320 may detect the speed and the impact amount of the two-wheeled vehicle, converts them into electrical signals, and output the same to the control unit 350. That is, the acceleration sensor 320 may detect the impact amount and the driving speed, which are information when an accident occurs, immediately before the accident, and may output the information to the control unit 350. In other words, the acceleration sensor 320 outputs speed information and impact amount information of the two-wheeled vehicle to the control unit 350.

The timer 330 may continuously measure time and output time information to the control unit 350 when an accident occurs.

The communication unit 340 may include one or more modules enabling wireless communication between the two-wheeled vehicle accident reporting device 120 and the driver terminal 110, or between the two-wheeled vehicle accident reporting device 120 and the network in which the two-wheeled vehicle accident severity prediction server 130 is located. For example, the communication unit 340 may include a mobile communication module and a short-range communication module.

The mobile communication module may transmit/receive wireless signals to and from at least one of a base station, an external terminal, and a server through a mobile communication network. Such a wireless signal may include various types of data according to transmission and reception of a voice call signal, a video call signal, a text message or a multimedia message.

A short-range communication module refers to a module for short-distance communication. As a short range communication technology, Bluetooth, Radio Frequency Identification (RFID), Infrared Data Association (IrDA), Ultra Wideband (UWB), ZigBee, etc. may be used.

The control unit 350 is a controller to control the overall operation of the two-wheeled vehicle accident reporting device 120, specifically, may control the GPS sensor 310 and the acceleration sensor 320 to measure the speed, impact amount and position of the two-wheeled vehicle; may pair the two-wheeled vehicle accident reporting device 120 with the driver terminal 110 and, when an accident occurs, transmit the accident occurrence information including speed information, impact amount information, location information and time information along with the driver identification information to the two-wheeled vehicle accident severity prediction server 130 via the driver terminal 110. At this time, when the impact amount is equal to or greater than a preset threshold, the control unit 350 determines that an accident has occurred, and then, transmit the accident occurrence information including speed information, impact amount information, location information and time information along with the driver identification information to the two-wheeled vehicle accident severity prediction server 130.

Meanwhile, although not shown in FIG. 3, the two-wheeled vehicle accident reporting device 120 may store a program for the operation of the control unit 350, and may further include a storage (or memory) unit for temporarily storing input and output data (e.g., a phone book, a message, fixed images, moving pictures, etc.), as well as a power supply unit that receives application of external power and internal power under and then supplies power required for operation of each component.

FIG. 4 is a block diagram illustrating a schematic configuration of the inside of a deep learning recognition-based two-wheeled vehicle accident severity prediction server according to an embodiment of the present invention.

Referring to FIG. 4, the deep learning recognition-based two-wheeled vehicle accident severity prediction server 130 according to the present invention may include a database unit 410 and a control unit 420.

The database unit 410 may store a plurality of body information. Herein, the body information may include height, weight, blood type, and body parts with prior medical history.

The control unit 420 may receive the accident occurrence information including speed information, impact amount information, location information and time information along with the driver identification information from the two-wheeled vehicle accident reporting device 120, analyze road information and weather information at a corresponding location based on the location information, and then, determine accident severity by inputting and deep learning the body information corresponding to the driver identification information among a plurality of body information stored in the data base unit 410, as well as the speed information, impact amount information, road information, weather information and time information. At this time, a learning rate, target, and the number of epochs, which are hyper parameters determined during learning, may be set to 0.00002, 0.000001 and 100, respectively.

Further, the control unit 420 may notify the accident to different relief organizations for each accident severity according to the deep learning result.

Further, the control unit 420 may impart the priority to the subject contacts based on at least one of the number of calls of the driver terminal 110, call time, call time history, number of texts, number of mobile messenger access times, number of mobile messenger tag times, and number of times associated with stored pictures, and then notify the accident to the corresponding contact for each accident severity according to the deep learning result.

Referring to FIG. 5, hardware capable of realizing the function of the two-wheeled vehicle accident severity prediction server 130 will be described. FIG. 5 is a block diagram illustrating an example of hardware capable of realizing the function of the two-wheeled vehicle accident severity prediction server according to the embodiment of the present invention.

The function of the two-wheeled vehicle accident severity prediction server 130 may be realized using, for example, the hardware resources shown in FIG. 5. That is, the function of the two-wheeled vehicle accident severity prediction server 130 is realized by controlling the hardware shown in FIG. 5 using a computer program.

As shown in FIG. 5, this hardware may mainly include a CPU 502, a ROM (Read Only Memory) 504, a RAM 506, a host bus 508 and a bridge 510. Further, the hardware may include an external bus 512, an interface 514, an input unit 516, an output unit 518, a memory unit 520, a drive 522, a connection port 524 and a communication unit 526.

The CPU 502 may functions for example, as an arithmetic processing unit or a control unit, and thus may control overall or a part of the operation of each component based on various programs recorded in the ROM 504, the RAM 506, the memory unit 520 or the removable recording medium 528. The ROM 504 is an example of a memory device that stores a program read by the CPU 502, data used for arithmetic operation, and the like. In the RAM 506, for example, a program read by the CPU 502, different parameters varying when the program is executed, etc. are temporarily or permanently stored.

These elements may be connected to each other via, for example, a host bus 508 enabling high-speed data transmission. On the other hand, the host bus 508 may be connected to an external bus 512 having a relatively low data transmission rate, for example, via a bridge 510. As the input unit 516, for example, a mouse, a keyboard, a touch panel, a touch pad, a button, a switch, a lever, and the like are used. Further, as the input unit 516, a remote controller capable of transmitting a control signal using infrared or other radio waves may be used.

As the output unit 518, for example, a display device such as a cathode ray tube (CRT), a liquid crystal display (LCD), a plasma display panel (PDP) or an electro-luminescence display (ELD) may be used. Further, as the output unit 518, an audio output device such as a speaker or headphones, or a printer may be used.

The memory unit 520 is a device for storing various types of data. As the memory unit 520, for example, a magnetic storage device such as an HDD is used. Further, as the memory unit 520, a semiconductor storage device such as an SSD (Solid State Drive) or a RAM disk, an optical storage device, a magneto-optical storage device, or the like may be used.

The drive 522 is a device that reads information recorded on the removable recording medium 528 as a detachable recording medium, or records information into the removable recording medium 528. As the removable recording medium 528, for example, a magnetic disk, an optical disk, a magneto-optical disk, a semiconductor memory, etc. may be used. Further, in the removable recording medium 528, a program for defining the operation of the two-wheeled vehicle accident severity prediction server 130 may be stored.

An access port 524 refers to a port for connecting any external connection device 530 and may include, for example, USB (Universal Serial Bus) port, IEEE 1394 port, SCSI (Small Computer System Interface), RS-232C port, or an optical audio terminal. The external connection device 530 may include, for example, a printer or the like.

The communication unit 526 refers to a communication device for accessing the network 532. As the communication unit 526, for example, a communication circuit for wired or wireless LAN, a communication circuit for WUSB (Wireless USB), a communication circuit for a cellular phone network, or the like may be used. The network 532 may be, for example, a wired or wireless accessible network.

The hardware of the two-wheeled vehicle accident severity prediction server 130 has been described above. However, the above-mentioned hardware is merely an example, while modifications with omission of some elements or with addition of new elements are also possible.

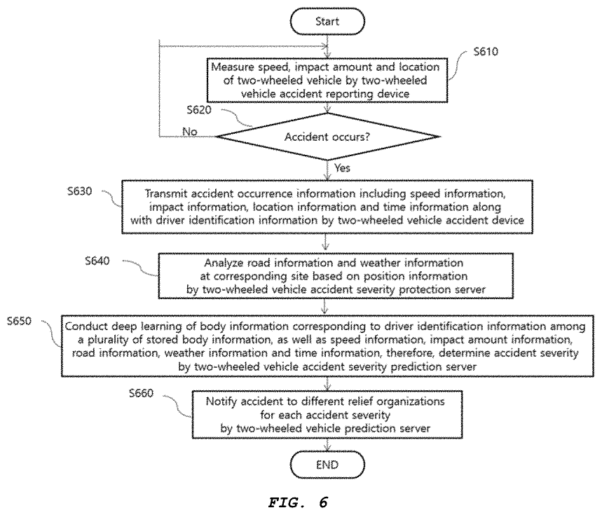

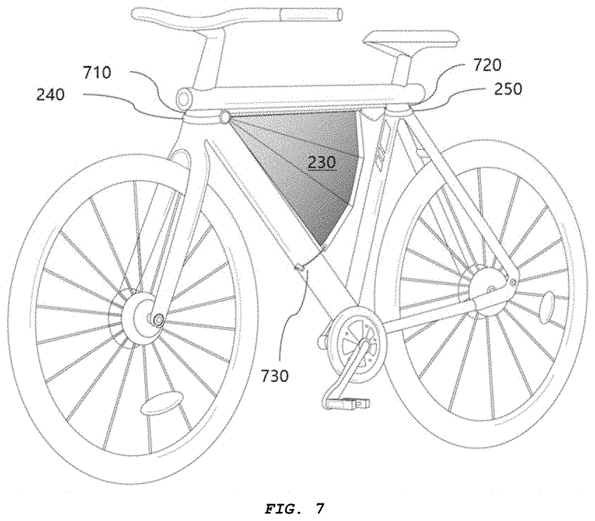

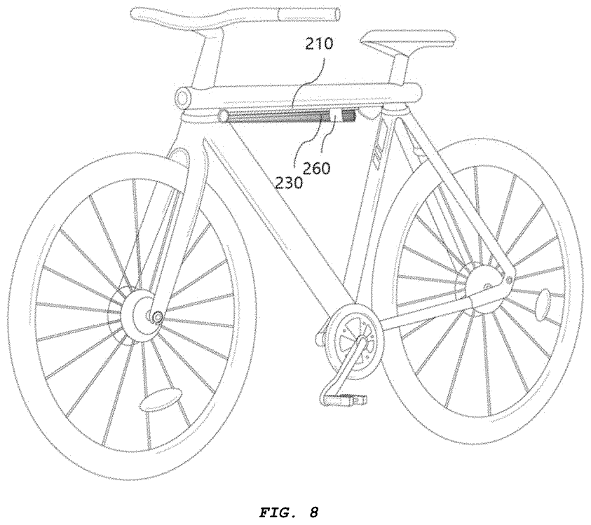

FIG. 6 is a flowchart illustrating a method for predicting the accident severity of a two-wheeled vehicle based on deep learning recognition according to an embodiment of the present invention.

Referring to FIG. 6, the two-wheeled vehicle accident reporting device 120 may be mounted on the two-wheeled vehicle to measure the speed, impact amount and position of the two-wheeled vehicle (S610).

The two-wheeled vehicle accident reporting device 120 may determine whether an accident has occurred by measuring whether the impact amount is equal to or greater than a preset threshold (S620).

When it is determined that an accident has occurred, the two-wheeled vehicle accident reporting device 120 may transmit accident occurrence information including speed information, impact amount information, location information and time information along with driver identification information to the two-wheeled vehicle accident severity prediction server 130 (S630). At this time, the two-wheeled vehicle accident reporting device 120 may directly transmit the driver identification information and the accident occurrence information to the two-wheeled vehicle accident severity prediction server 130, otherwise, may transmit the driver identification information and the accident occurrence information to the two-wheeled vehicle accident severity prediction server 130 through the diver terminal 110.

The two-wheeled vehicle accident severity prediction server 130 may analyze road information and weather information at a corresponding location based on the location information received from the two-wheeled vehicle accident reporting device 120 (S640).

The two-wheeled vehicle accident severity prediction server 130 may determine the accident severity by deep learning the body information, which correspond to the driver identification information, among the plurality of pre-stored body information, as well as speed information, impact amount information, road information, weather information and time (S650). That is, the two-wheeled vehicle accident severity prediction server 130 uses an accident severity prediction deep-learning algorithm having two hidden layers, and then, classifies the accident into four (4) types of unknown, minor, severe and fatal injuries based on the input values. In this regard, the input value may comprise four (4) types of information among body information of the victim of a bicycle accident, such as height, weight, blood type and body part with prior medical history, as well as five (5) types of information including impact amount, driving speed just before the accident, road type, weather and accident time, which are information at the time of the accident. That is, the above total 9 input values may be classified into final four (4) types of accidents through optimized weighted value and activation functions determined by training the deep learning algorithm. At this time, hyper parameters determined during learning, specifically, a learning rate, a goal and the number of epochs may be preset as 0.00002, 0.00001 and 100, respectively.

Then, the two-wheeled vehicle accident severity prediction server 130 may notify the accident to different relief organizations for each accident severity according to the deep learning result (S660). For example: if the accident severity is unknown, the two-wheeled vehicle accident severity prediction server 130 may contact an acquaintance immediately after the accident occurs; if the accident severity is minor, the above server may contact the acquaintance and insurance company (or the jurisdiction city hall (in the case of group insurance)); if the accident is serious, the server may contact acquaintances, insurance company and police station; and, if the accident severity is fatal injuries, the sever may contact acquaintances, insurance company, police station and ambulance. Further, in the case of post-treatment of an accident when a predetermined time has elapsed immediately after the accident, the two-wheeled vehicle accident severity prediction server 130 may match a company suitable for accident severity such as a hospital, a claim adjuster, a repair company and a funeral service company, and then, may provide the above process to the driver terminal 110.

In addition, the two-wheeled vehicle accident severity prediction server 130 may provide the pre-stored driver's body information to insurance companies, hospitals, claim adjusters, and the like, immediately after the accident and at the time of post-treatment after the accident.

The above-described method may be implemented through various means. For example, the embodiments of the present invention may be implemented by hardware, firmware, software, or a combination thereof.

In the case of implementation through hardware, the method according to the embodiments of the present invention may be implemented by one or more of Application Specific Integrated Circuits (ASICs), Digital Signal Processors (DSPs), Digital Signal Processing Devices (DSPDs), and Programmable Logic Devices (PLDs), FPGAs (Field Programmable Gate Arrays), processors, controllers, microcontrollers and microprocessors, and the like.

In the case of implementation by firmware or software, the method according to the embodiments of the present invention may be implemented in the form of a module, procedure or function that performs the functions or operations described above. The software code may be stored in a memory unit and driven by the processor. The memory unit may be located inside or outside the processor, and may transmit and receive data to and from the processor by various known means.

FIG. 7 illustrates a state in which a two-wheeled vehicle accident reporting device is mounted on a two-wheeled vehicle, and the retro-reflective cover is unfolded.

Referring to FIG. 7, the first fixture 240 of the two-wheeled vehicle accident reporting device 120 is fitted to the head tube 710 of the two-wheeled vehicle, while the second fixture 250 is fitted to the seat tube 720 of the two-wheeled vehicle so that the two-wheeled vehicle accident reporting device 120 can be mounted on the two-wheeled vehicle.

Then, the retro-reflective cover 230 is unfolded in a scallop shape, while the other end thereof is fixed to the down tube 730 of the two-wheeled vehicle.

FIG. 8 illustrates a state in which the retro-reflective cover is folded.

Referring to FIG. 8, when the retro-reflective cover 230 is folded, it may be fixed to the body 210 of the two-wheeled vehicle accident reporting device 120 by the fixing band 260.

As described above, the embodiments disclosed herein have been described with reference to the accompanying drawings. As such, the embodiments shown in each drawing should not be construed as being limited, and may be combined with each other by those skilled in the art fully understanding the contents of the present specification and, if combined, it may be construed that some components may be omitted.

In this regard, the terms or words used in the present specification and claims should not be construed as being limited to conventional or dictionary meanings, but should be interpreted as meanings and concepts consistent with the technical ideas disclosed in the present specification.

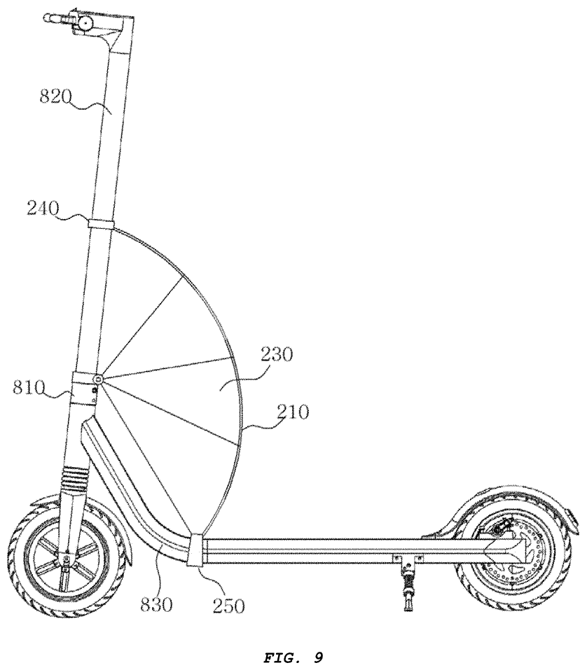

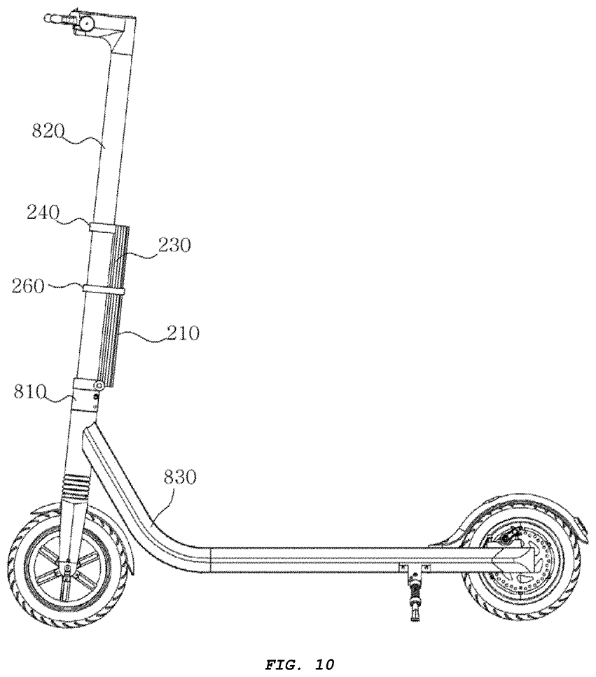

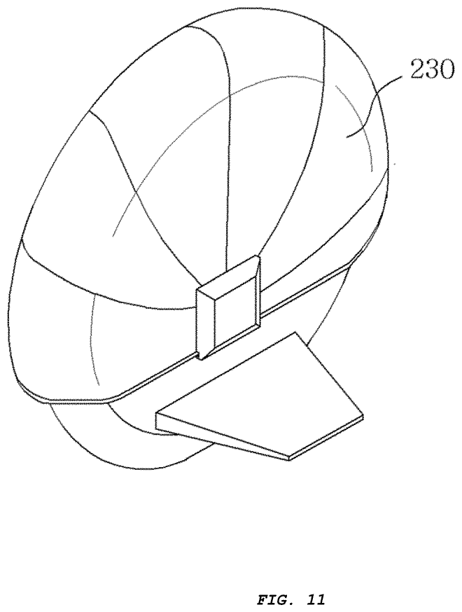

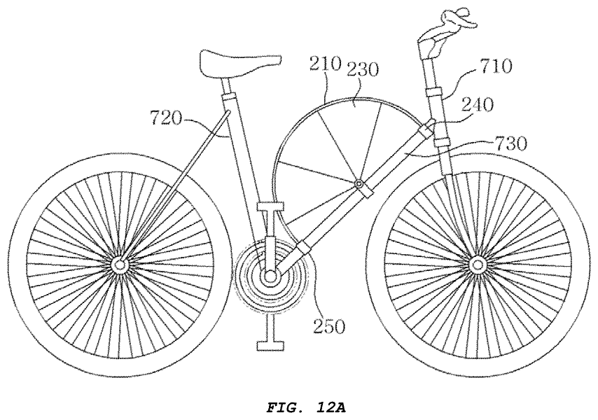

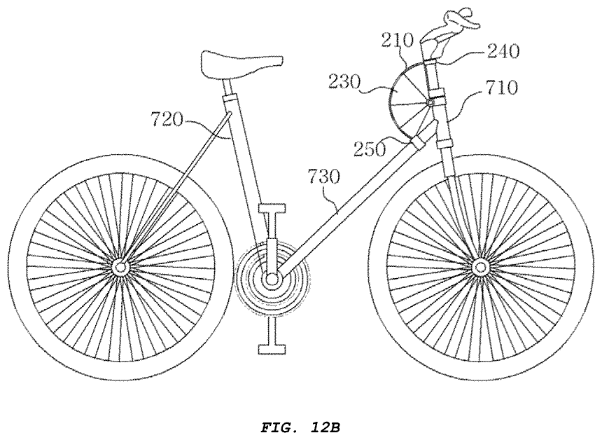

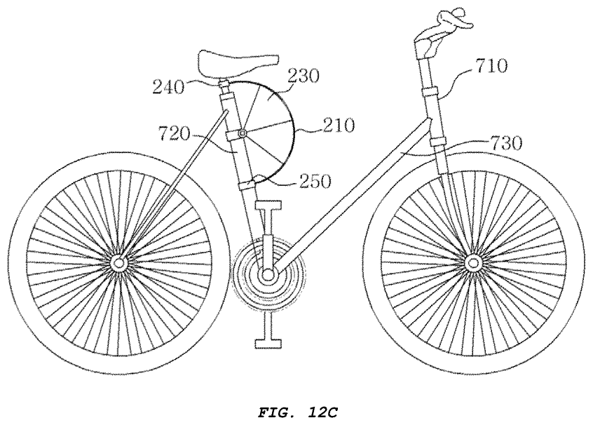

FIG. 9 also illustrates another embodiment according to the present invention, in which the device of the preset invention is mounted on a kickboard. In the case of FIG. 10, the device of FIG. 9 is shown in a folded state. FIG. 11 illustrates another embodiment of the present invention, that is, a state in which the device of the present invention is mounted on a power wheel. More specifically, the present embodiment has a structure that can be covered with the power wheel, and has retro-reflective covers on both sides of the power wheel. Of course, other embodiments mounted on the electric wheel can also be folded and carried.

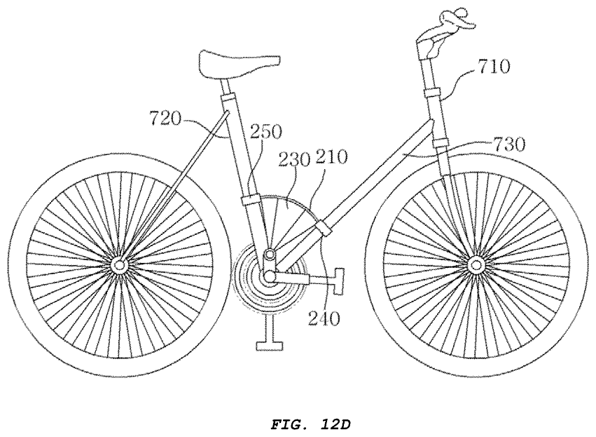

FIG. 12 is another embodiment according to the present invention, in which the body of the device of the present invention is mounted on any one of the top tube, down tube, seat tube, head tube or hand shaft constituting a vehicle body of the two-wheeled vehicle, wherein the retro-reflective cover fixed and folded to the body is opened. The retro-reflective cover may be opened and fixed to a part of the body of the two-wheeled vehicle, or may be maintained in an open state due to the rigidity of the retro-reflective cover itself.

Meanwhile, it is of course possible that the body of the device according to the present invention may be mounted on the vehicle body of various types of two-wheeled vehicles such as a kickboard as well as a bicycle.

Therefore, the embodiments described in the present specification and the configurations shown in the drawings are only the embodiments disclosed in the present specification, and do not represent all the technical ideas disclosed in the present specification, therefore, it should be understood that various equivalents and variations able to replace the embodiments at the time of the present application are possibly proposed.

1. A two-wheeled vehicle accident severity prediction systems, comprising:
a two-wheeled vehicle accident reporting device, which is mounted on a two-wheeled vehicle, measures speed and position of the two-wheeled vehicle using a plurality of sensors and, when an accident occurs, transmits accident occurrence information including speed information, impact amount information, location information and time information along with driver identification information through a wireless communication network; and
a deep learning recognition-based two-wheeled vehicle accident severity prediction server, which is provided with one or more processors to constitute a neural network that stores a plurality of body information, analyzes road information and weather information at a corresponding location based on the location information received from the two-wheeled vehicle accident reporting device, conducts deep learning of the body information corresponding to the driver identification information among the plurality of body information, as well as the speed information, impact amount information, road information, weather information and time information so as to determine the accident severity, and then, notifies the accident to different relief organizations for each accident severity according to a result of the deep learning,
wherein the two-wheeled vehicle accident reporting device includes:
a body mounted on a two-wheeled vehicle;
a retro-reflective cover, which has one end fixed to a lower end of the body and thus is configured to be folded and unfolded in a scallop shape, and reflects light; and
a control board, which is mounted on one side of the body, measures the speed and position of the two-wheeled vehicle using a plurality of sensors and, when an accident occurs, transmits the accident occurrence information including the speed information, impact amount information, location information and time information along with the driver identification information through a wireless communication network to the two-wheeled vehicle accident severity prediction server.

2. The system according to claim 1, wherein the body of the retro-reflective cover is mounted on a lower portion of a top tube in the two-wheeled vehicle.

3. The system according to claim 1, wherein the retro-reflective cover has the other end fixed to a down tube in the two-wheeled vehicle when the cover is unfolded.

4. The system according to claim 1, wherein the control board includes an acceleration sensor to measure a speed and an impact amount of the two-wheeled vehicle, and a GPS sensor to measure a position of the two-wheeled vehicle.

5. The system according to claim 1, wherein a learning rate, a goal and the number of epochs, which are hyper parameters determined in the deep learning, are preset to 0.00002, 0.000001 and 100, respectively.

6. The system according to claim 1, wherein the body information includes height, weight, body type and body part with prior medical history.

7. The system according to claim 1, wherein the one or more processors impart the priority to the subject contacts based on at least one of the number of calls of a mobile terminal possessed by the driver, call time, call time history, number of texts, number of mobile messenger access times, number of mobile messenger tag times and number of times associated with stored pictures, and then, notify the accident to the corresponding contact for each accident severity according to the deep learning result.

8. A two-wheeled vehicle accident severity prediction systems, comprising:
a two-wheeled vehicle accident reporting device, which is mounted on a two-wheeled vehicle, measures speed and position of the two-wheeled vehicle using a plurality of sensors and, when an accident occurs, transmits accident occurrence information including speed information, impact amount information, location information and time information along with driver identification information through a wireless communication network; and
a deep learning recognition-based two-wheeled vehicle accident severity prediction server, which is provided with one or more processors to constitute a neural network that stores a plurality of body information, analyzes road information and weather information at a corresponding location based on the location information received from the two-wheeled vehicle accident reporting device, conducts deep learning of the body information corresponding to the driver identification information among the plurality of body information, as well as the speed information, impact amount information, road information, weather information and time information so as to determine the accident severity, and then, notifies the accident to different relief organizations for each accident severity according to a result of the deep learning,
wherein the two-wheeled vehicle accident reporting device includes:
a body mounted on any one of a top tube, a down tube, a seat tube, a head tube or a handle shaft of the two-wheeled vehicle;
a retro-reflective cover, which has one end fixed to a lower end of the body and thus is configured to be folded and unfolded in a scallop shape, and reflects light; and
a control board, which is mounted on one side of the body, measures the speed and position of the two-wheeled vehicle using a plurality of sensors and, when an accident occurs, transmits the accident occurrence information including the speed information, impact amount information, location information and time information along with the driver identification information through a wireless communication network to the two-wheeled vehicle accident severity prediction server.
